(19) United States
(12) Patent Application Publication
(10) Pub. No.: US 2025/0166623 A1
(43) Pub. Date: May 22, 2025

(54) THRESHOLD-BASED VARIABLE CHUNK CREATION FOR SPEECH RECOGNITION

(71) Applicant: INTERNATIONAL BUSINESS MACHINES CORPORATION, ARMONK, NY (US)

(72) Inventor: Toru Nagano, TAITO-KU (JP)

(21) Appl. No.: 18/515,346

(22) Filed: Nov. 21, 2023

(51) Int. Cl. G10L 15/22; G10L 15/06; G10L 15/16

(52) U.S. Cl. CPC G10L 15/22; G10L 15/063; G10L 15/16

(57) ABSTRACT

A method, computer system, and a computer program product are provided. Audio data is received. The audio data is examined by time frame and to obtain a time-dependent vocal characteristic of the audio data. In response to the time-dependent vocal characteristic falling below an intensity threshold value at a first time point, a first chunk of the audio data is created from the audio data from a beginning time point to the first time point. The first chunk of the audio data is sent to a speech recognition machine learning model. The examining, the creating, and the sending are iteratively repeated for additional chunks of the audio data.

### BACKGROUND

The present invention relates generally to the fields of automatic speed recognition, machine learning for speech recognition, and processing of audio data to facilitate effective machine learning automatic speech recognition.

### SUMMARY

According to one exemplary embodiment, a computer-implemented method is provided. Audio data is received. The audio data is examined by time frame and to obtain a time-dependent vocal characteristic of the audio data. In response to the time-dependent vocal characteristic falling below an intensity threshold value at a first time point, a first chunk of the audio data is created from the audio data from a beginning time point to the first time point. The first chunk of the audio data is sent to a speech recognition machine learning model. The examining, the creating, and the sending are iteratively repeated for additional chunks of the audio data. A computer system and computer program product corresponding to the above method are also disclosed herein.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment in which vocal characteristic-based segmentation of audio data is performed according to at least one embodiment;

FIG. 2 illustrates a vocal characteristic-based segmentation process for segmenting audio data into variable-length chunks according to at least one embodiment;

FIG. 3A illustrates aspects of threshold determination according to at least one embodiment to determine a threshold value for use in variable chunk decoding;

FIG. 3B illustrates aspects of a two frequency distribution threshold determination according to at least one embodiment to determine a threshold value for use in variable chunk decoding;

FIG. 4 illustrates aspects of variable chunk decoding according to at least one embodiment;

FIG. 5 illustrates aspects of portioning of audio data into vocal characteristic-based variable length chunks according to at least one embodiment; and

FIG. 6 illustrates a pipeline for speech-to-text conversion using variable chunk decoding according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The following described exemplary embodiments provide a computer system, a method, and a computer program product for performing vocal characteristic-based chunk creation for creating variable length chunks for automatic speech recognition. Automatic speech recognition programs and machine learning models analyze acoustic speech signals to determine what words, phrases, or sounds are being spoken. The automatic speech recognition is helpful in a variety of applications such as transcription of spoken words, automated assistance from a question-and-answer chatbot, etc. The present embodiments provide an improved mode of preparing the audio data for inputting to the machine learning model so that benefits of latency and accuracy in the automatic speech recognition are maximized. The present embodiments incorporate examination of a time-dependent vocal characteristic of audio data to determine a suitable time to generate a segment or chunk of the audio data to send to the machine learning model. The present embodiments identify when the time-dependent vocal characteristic crosses a threshold value to determine the suitable time point for generating the segment or chunk of audio data. At least some embodiments also include determining a suitable threshold value for the identification, e.g., using audio training data to determine a suitable threshold value for a time-dependent vocal characteristic that is being monitored.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as vocal characteristic-based variable-length audio data chunking program 116. In addition to vocal characteristic-based variable-length audio data chunking program 116, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and vocal characteristic-based variable-length audio data chunking program 116, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

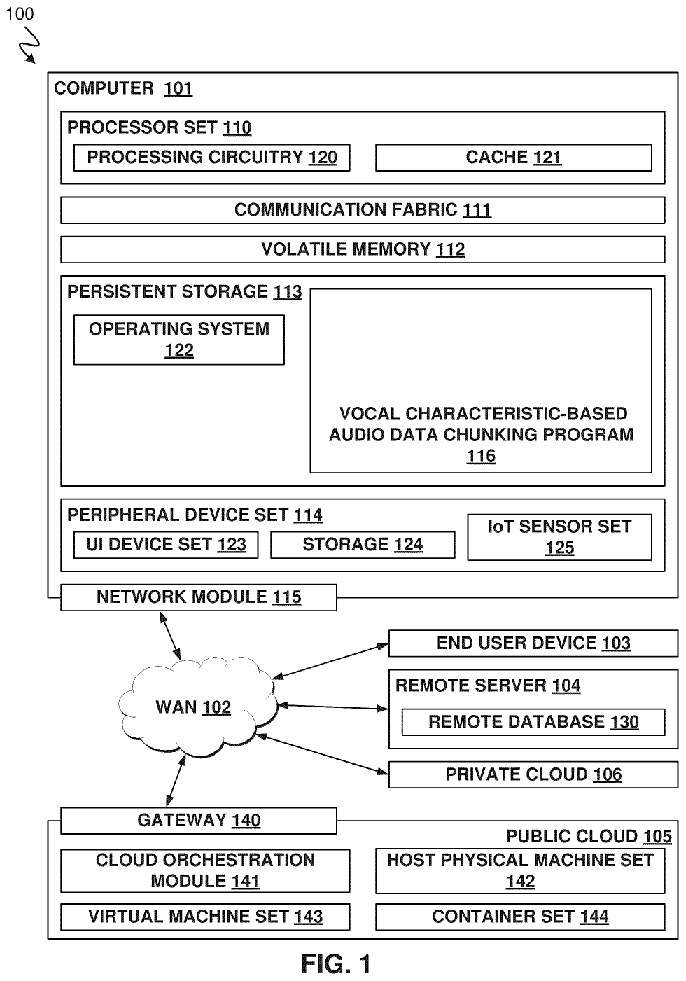

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in vocal characteristic-based, variable-length audio data chunking program 116 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in vocal characteristic-based variable-length audio data chunking program 116 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing exceptionally large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computer 101 in some embodiments also hosts one or more machine learning models for automatic speech recognition. An automatic speech recognition machine learning model is one embodiment stored in the persistent storage 113 of the computer 101. The audio data chunks created via the vocal characteristic-based variable-length audio data chunking program 116 are input to the automatic speech recognition machine learning model via an intra-computer transmission within the computer 101, e.g., via a bus to a different memory region hosting the automatic speech recognition machine learning model. This machine learning model in some embodiments is a recurrent neural network (RNN).

In some embodiments, one or more machine learning models for automatic speech recognition are stored in computer memory storage of a computer positioned remotely from the computer 101, e.g., in a remote server 104 or in an end user device 103. In this embodiment, the audio data chunks created via the vocal characteristic-based variable-length audio data chunking program 116 are input to the automatic speech recognition machine learning model via a transmission that starts from the computer 101, passes through the WAN 102, and ends at the destination computer/server that hosts the machine learning model. This machine learning model in some embodiments is a recurrent neural network (RNN). In such embodiments, this remote machine learning model is configured to send its output back to the computer 101 (e.g., via a return transmission through the WAN 102) so that the speech data, e.g., in the form of text, is provided. The machine learning model receives the audio chunks, produces text of the audio via audio-to-text conversion, and transmits this text data back to the computer.

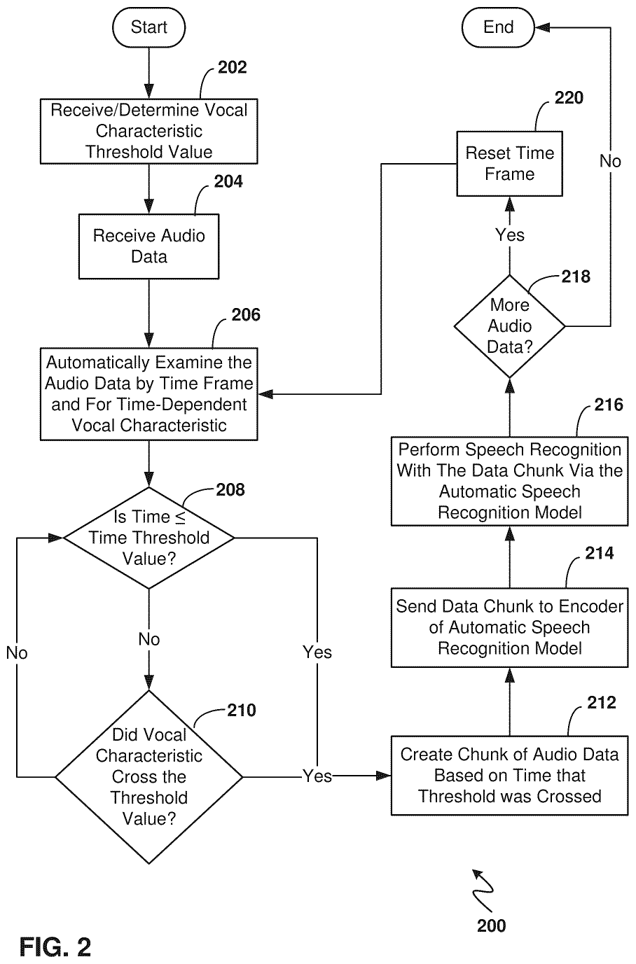

FIG. 2 illustrates a vocal characteristic-based variable-length audio data chunking process 200 according to at least one embodiment. This vocal characteristic-based variable-length audio data chunking process 200 is in at least some embodiments carried out via the vocal characteristic-based variable-length audio data chunking program 116 described above and shown in the computing environment 100 of FIG. 1. A vocal characteristic is measured and analyzed and is selected from a group consisting of acoustic intensity, acoustic tone, and change of acoustic intensity. The acoustic intensity of recorded sound is also known as a loudness of the sound and is measured in decibels.

In step 202 of the vocal characteristic-based variable-length audio data chunking process 200, a threshold value for the vocal characteristic is received and/or determined. This threshold value refers to a particular value of the selected vocal characteristic that is to be determined, e.g., a particular value of the acoustic intensity, the acoustic tone, and/or a change in the acoustic intensity. As will be explained subsequently, a recorded vocal characteristic profile value that crosses, e.g., hits or dips below, this threshold value is interpreted to be a point that is between words spoken by a user. Thus, the threshold value itself is used as a dividing point for dividing the acoustic recording file into a chunk for sending to the machine learning model. Specifically, to create a chunk the vocal characteristic profile is divided at the time value at which the intensity threshold was crossed. A recording file is ended at the threshold crossing time, so that one segment or chunk is able to be sent to the machine learning model and then a new recording file is started when the previous one ended. The crossing of the threshold is taken as a cue which predicts a break between spoken words that were captured in a recording.

The threshold value refers to a particular numerical value, e.g., for acoustic intensity a particular decibel level, e.g., a value of 58 decibels. If an audio recording includes a sound whose decibels are above that threshold level, the sound falling below that threshold level likely indicates that the speaker had a pause, e.g., between different words or ended a sentence or phrase. For the vocal characteristic that is an intensity change, the value is the change from a starting value. The intensity change is indicated by the formula Δv(t)=v(t)−v(t−1), where Δv is the intensity change, t is time, and v is the acoustic intensity. For the vocal characteristic that is tone, the units are oscillations of the sound wave per time. The tone is also referred to as a pitch of the sound.

This threshold value presents an appropriate place for dividing the audio recording into a chunk. By frequently creating chunks of smaller length instead of chunks of entire sentences or paragraphs, the machine learning model is able to use these variable-length chunks to provide more accurate and quick speech text data. The use of this threshold value will be explained subsequently for steps 206 and 210 of the vocal characteristic-based variable-length data chunking process 200.

For embodiments in which the vocal characteristic-based variable-length audio data chunking program 116 determines a new threshold value in step 202, the vocal characteristic-based variable-length audio data chunking program 116 samples and evaluates audio training data. Specifically, the vocal characteristic-based variable-length audio data chunking program 116 finds some local minima values within the vocal characteristic profile of the audio training data and uses those local minima values to help determine a suitable threshold value.

In some embodiments, the audio training data is captured by a microphone of the UI device set 123 of the computer 101. Using locally captured audio can help the program to automatically select a threshold value which accounts for any local noise produced via the local infrastructure such as the microphone. Thus, when the threshold value so-determined is later applied for voice recognition the threshold is used to chunk audio data that comes from the same microphone and that also could be skewed by microphone-specific variables.

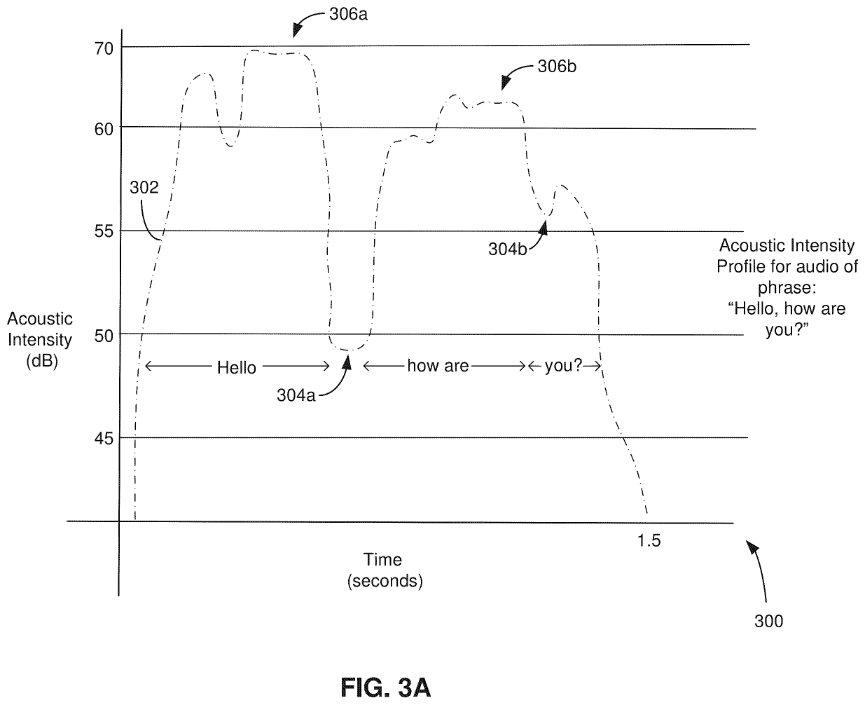

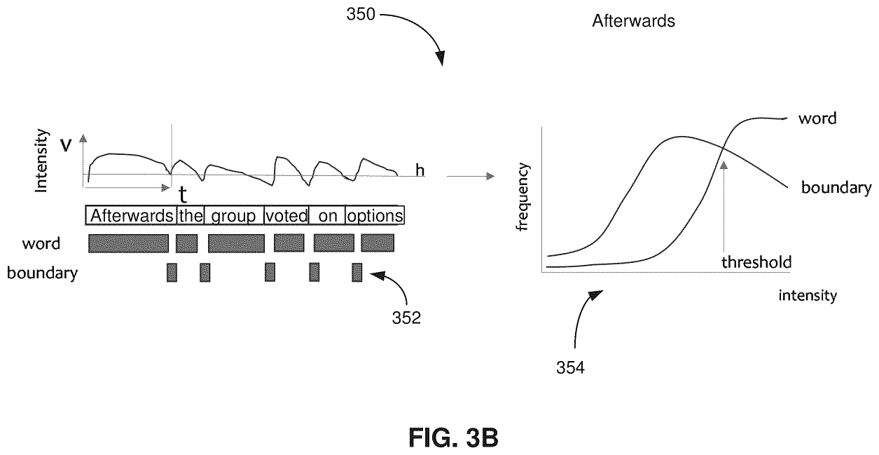

FIG. 3A shows an example of determining a suitable threshold value by the program 116 generating and analyzing an acoustic intensity graph 300 that is an x-y graph with acoustic intensity values in decibels (dBs) for the y-axis and time in seconds for the x-axis. From audio training data received, an acoustic intensity profile 302 is generated via the program 116. The acoustic intensity profile 302 illustrates the acoustic intensity of the sounds, e.g., words, that are recorded in the audio file. Within this profile 302, local minima such as the first local minimum 304a and second local minimum 304b are identified and used as potential threshold values. The first local minimum 304a has an acoustic intensity of around 49.5 decibels. The second local minimum 304b has an acoustic intensity of around 56 decibels. These two local minima are used as potential or candidate threshold values, depending on values of other local minima found within the audio training data.

In at least some embodiments, the audio training data is labeled with words that were spoken and recorded in the audio training data. In some embodiments, the labels include time stamps so that word initiation and word ending of a word are identified in the audio training data by matching the indicated times of the time stamps to the time values in the generated acoustic intensity profile line of the X-Y graph. In the example shown in FIG. 3A, the training audio data illustrates the acoustic intensity for the spoken language cluster or phrase “Hello, how are you?” that was spoken and captured in the recording. For this example, first and second acoustic peaks 306a, 306b are associated with the portions “Hello” and “how are”, respectively, of the spoken phrase. The first local minimum 304a is associated with a break between the words “Hello” and “how”. The second local minimum 304b is associated with a break between the words “are” and “you”. The first local minimum 304a has an acoustic intensity of around 49.5 decibels and the second local minimum 304b has an acoustic intensity of around 56 decibels. This graphing, therefore, indicates that at or around 49.5 decibels or at or around 56 decibels are candidates for being a suitable threshold value for subsequent variable-length vocal characteristic-based audio data chunking. Additional local minima are identified with further training data. The program 116 applies statistics to the candidate choices of threshold values to determine a suitable threshold decibel level value. In some instances several minutes of audio training data are used to assemble a group of candidate threshold values to determine the optimal threshold value to subsequently use for the variable-length data chunking. In some instances an hour's worth of audio training data is used to assemble a group of candidate threshold values to determine the optimal threshold value to subsequently use for the variable-length data chunking.

In some embodiments, the program 116 applies statistics to the candidate threshold values to determine an average threshold value, a median threshold value, a minimum threshold value, and/or a maximum threshold value, with the respective one being used as the suitable threshold value to pass on for remaining steps of the process 200.

In some embodiments, the program 116, as part of the analysis, automatically discards one or more local minima identified in the acoustic intensity profile. As part of the discarding, these points are not deemed to be threshold value candidates. This discard is in some embodiments due to an insufficient intensity value reduction before reaching the minimum. FIG. 3A shows some unnumbered local minima (e.g. one in the left peak 306a and another in the right peak 306b) which are discarded as candidate threshold values. Other minima (e.g., first and second local minima 304a, 304b) that are substantially different, e.g., lower, and within a near time frame indicate that the other minima are noise and not indicative of a word break. Comparison to the time stamp information for words and word breaks provided with training data also is useful for identifying which local minima to discard, e.g., when such local minima fall within a word instead of between words.

The acoustic intensity value graphs are also translatable to an intensity change X-Y graph where the Y variable indicates the change of the intensity at a particular time. For this embodiment, a maxima is taken as a candidate threshold value. A greater change indicates a likelihood of a break in a word, so this embodiment looks for a local maximum instead of a local minimum.

Similar graphs for tone are implemented in some embodiments to determine a suitable threshold value. The y-axis variable is oscillations per second which represent the tone or pitch. Local minima in the oscillations per second (Y-variable) are also identified in the oscillations per second values to find candidate threshold values.

In at least some embodiments, the program 116 determines the frequency distribution of intensity to find a threshold value. This alternative is often used for unlabeled training data. For example, an audio file with normalized decibels is divided into bins of 10 db, 20 db, 30 db, 40 db, 50 db, 60 db, 70 db, 80 db, 90 db, and 100 db. For a set of corresponding acoustic intensity measurements of the sound recorded within a time frame, the program 116 determines a set of a number of measurements within each bin: 100, 124, 20, 34, 4, 24, 60, 755, 425, and 20. The program 116 determines that the bin with the lowest number of values (“4”) is the 50 db bin and is, therefore, a suitable candidate for a threshold value. The acoustic intensity value of 50 db of the recordings in the lowest-number bin is taken and used as the threshold value in some embodiments.

In at least some embodiments, the threshold value determination is initiated by the program 116 receiving an audio file to use as training data. This audio file is in one of various audio file formats such as an uncompressed audio format, a lossless compression format, and/or a lossy compression format such as an mp3 file.

In some embodiments, a voice activity detection (VAD) algorithm, e.g., a power-based voice activity detection algorithm, is applied to the received audio file to confirm that the recording includes voice data instead of extraneous noise. This voice activity detection algorithm is deployed in some embodiments in the computer 101 and/or is accessed via the computer 101 transmitting through the WAN 102 to a remote server 104 that hosts the voice activity detection algorithm. This use of VAD represents a pre-vetting step to vet the audio to ensure that voice data is included. This pre-vetting helps avoid non-voice sounds from interfering with the determination of a suitable threshold value.

The vocal characteristic-based chunking program 116 in some embodiments bases the selected threshold value on regional dialect/language typically spoken in a geographical area and based on decibel characteristics of speakers of a particular dialect/language. A dialect/language often has common intensity and/or tone characteristics associated with spoken words. This emphasis on dialect/language is performed in some instance by gathering audio training data from speakers from that region or from speakers speaking a particular language. In some embodiments, a table of recommended threshold level values for region/language is stored in a memory database of the computer 101 that is accessible to the vocal characteristic-based variable-length chunking program 116. The vocal characteristic-based variable-length chunking program 116 also in at least some embodiments generates a user interface which enables a user to select and/or input the intensity threshold value.

In some embodiments, the vocal characteristic-based variable-length chunking program 116 at the computer 101 performs step 202 by receiving the threshold value from another source such as from a related program on an external computer. Such reception might occur from a transmission through a wide area network 102 to which the computer 101 is connected.

In some embodiments, the training data that is used in step 202 is captured from spoken words of a user who will subsequently be using the vocal characteristic-based variable-length chunking program 116 in conjunction with the machine learning model for speech recognition and speech-to-text transcription. In this way, a user-specific threshold is selected that will best suit, e.g., predict the intensity values and/or tone of word breaks, of the particular user whose future words will be captured and predicted. In some embodiments, the training data is captured from spoken words of a user speaking a particular language which will be the primary language expected to be used for future use of the vocal characteristic-based variable-length chunking program 116 in conjunction with the machine learning model for speech recognition and speech-to-text transcription. For a bilingual user, the user could interact with a graphical user interface of the program 116 to input a threshold value for a first language spoken and a second different threshold value for a second language spoken. In this way, language-specific tendencies for pronunciation, word breaks, intensity, tone, and/or intensity variation are used for the program 116 to automatically select a language-specific threshold value that will best suit the words and sounds that in the future are expected to be captured and predicted via the program 116.

In at least some embodiments, the step 202 occurs as a determination based on inputs of the received audio data of step 204. The vocal characteristic-based variable-length audio data chunking program 116 measures vocal intensity, tone, and/or intensity change of the received audio data and determines an average vocal intensity, a vocal intensity change rate, and/or a vocal intensity change amount within a time frame. The vocal characteristic-based variable-length audio data chunking program 116 determines the threshold level based on at least one of the average vocal intensity within the time frame, a vocal intensity change rate within the time frame, a vocal intensity change amount within the time frame, and/or average tone within the time frame. In some embodiments, the threshold value is automatically selected by the program 116 by multiplying the average measured target characteristic by some factor greater than one, e.g., by 1.1 of the average vocal intensity, with this product result being the threshold value. In some embodiments, the threshold value is automatically selected by the program 116 by multiplying the average vocal characteristic value by some factor less than one, e.g., by 0.9 of the average vocal intensity, with this product result being the threshold value. By using a weight factor of greater than one, the sensitivity of the tracking system for predicting word breaks is predicted and fewer misses will occur. By using a weight factor of less than one, the sensitivity of the tracking system for predicting word breaks is adjusted so that fewer false positive predictions occur.

FIG. 3B illustrates aspects of a two frequency distribution threshold determination 350 according to at least one embodiment to determine a threshold value for use in variable chunk decoding. For this embodiment, in addition to labelling of word information for the audio training data as described above for the embodiment shown in FIG. 3A this embodiment also incorporates boundary labelling 352 for the audio training data. For the two-frequency distribution X-Y graph 354 shown in FIG. 3B, the horizontal axis for the X-variable is not time but instead is the acoustic intensity of the recorded speech. For the two-frequency distribution X-Y graph 354 shown in FIG. 3B, the vertical axis for the Y-variable is not acoustic intensity but instead is the frequency of the particular intensity value, e.g., the frequency at which the recorded sound profile had a particular intensity value. For a spoken word, often the last part of the spoken word is associated with a reduced acoustic intensity. Such a weak speech portion in the word segment is located in the distribution with the lower intensity of the word line in the two-frequency distribution X-Y graph 354. In such cases, distinguishing accurately between word and boundary is solved by representing the second labelling in the same way as the first labelling with the left set of values indicating normalized decibels/bins and the second set indicating the sound values at the certain decibels:
word: (10, 20, 30, 40, 50, 60, 70, 80, 90, and 100) db=(5, 8, 12, 20, 34, 46, 70, 100, 202, 100)
boundary: (10, 20, 30, 40, 50, 60, 70, 80, 90, and 100) db=(20, 30, 43, 86, 124, 180, 123, 82, 32, 10)
   Because the intersection of the two lines here in the two-frequency distribution X-Y graph 354 is between the 70 db and 80 db bins, a halfway point (75 db) between these two bins is selected as the candidate threshold value for acoustic intensity.

In step 204 of the vocal characteristic-based audio data chunking process 200, audio data is received. In at least some embodiments, the audio data is received from a microphone that is connected to the computer 101 shown in FIG. 1 and that is part of the UI device set 123. Once received at this microphone, an intra-computer transmission within the computer 101 transmits the audio recording data from the microphone to the vocal characteristic-based variable-length audio data chunking program 116. In other embodiments, the audio data is received via a transmission over the internet, e.g., via a transmission from an external computer such as end user device 103 and/or remote server 104 through the wide area network 102 and to the computer 101 and eventually to the vocal characteristic-based variable-length data chunking program 116 within the computer 101.

This audio file is in one of various audio file formats such as an uncompressed audio format, a lossless compression format, and/or a lossy compression format such as an mp3 file. This audio file with the desired format is generated in some embodiments via the microphone-related components of the computer 101. When received via a transmission, the computer 101 generates an internal transmission to deliver the received file to the program 116 or to internal memory storage that is accessible to the program 116.

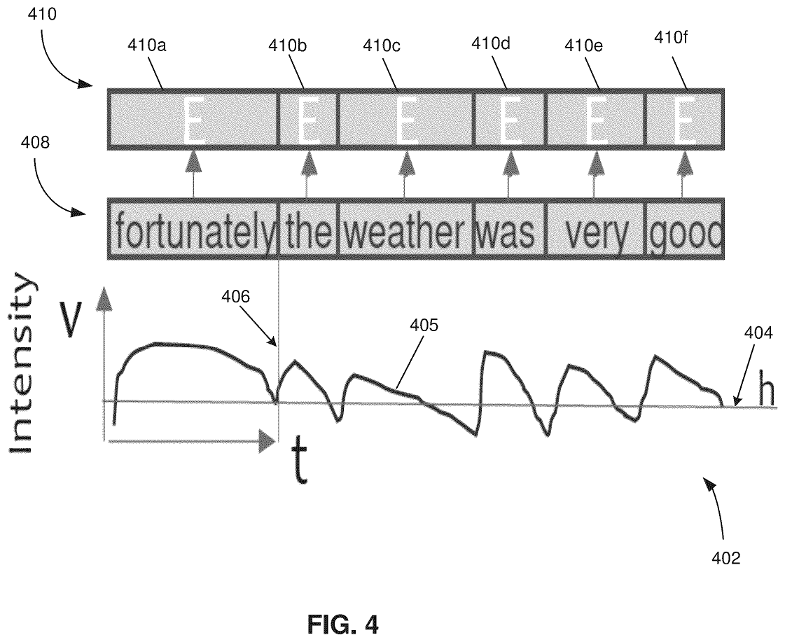

In step 206 of the vocal characteristic-based audio data chunking process 200, the audio data is examined by time frame and to obtain a time-dependent vocal characteristic. As part of the step 206, for the embodiment in which the time-dependent vocal characteristic is the intensity the program 116 generates an intensity profile graph which graphs the vocal intensity variable against the time variable for the newly-received audio data. FIG. 4 illustrates with the vocal intensity profile graph 402 an example of such an X-Y graph. This profile graph 402 is similar to the X-Y graph 300 shown in FIG. 3A but is generated from recorded utterance, e.g., live-recorded utterance of a user, instead of from training data. The live recording is received without the program 116 knowing which spoken words are recorded in the live audio recording, whereas much of the audio training data was labeled training data. The vocal intensity profile graph 402 includes as the X-variable a time (t) and includes as the Y-variable a vocal intensity (h) for a recorded audio file that was received in step 204. The variable line 405 that is shown and tracked in FIG. 4 exhibits the intensity of the sound, e.g., the voice, recorded in the received audio file. This variable line 405 represents the acoustic intensity of the audio data that is to be chunked in the process 200. FIG. 4 shows that this profile line 405 ebbs and falls. Reductions leading to valleys in this profile line are usually indicative of a break in the words spoken such as a break between two consecutive words. In other embodiments, the program 116 generates a similar graph for tone of the recorded sound per time or change in intensity per time from a particular starting value of intensity.

In step 208 of the vocal characteristic-based audio data chunking process 200, a determination is made whether a time threshold has been passed. If the determination of step 206 is affirmative in that the time threshold has passed, the vocal characteristic-based audio data chunking process skips step 210 and proceeds to step 212. If the determination of step 208 is negative in that the time threshold has not been passed, the vocal characteristic-based audio data chunking process 200 proceeds to step 210. For the X-Y acoustic intensity profile graph, a time threshold is chosen which is typically longer than an average time taken to speak a word. This time threshold also may be determined based on audio training data, e.g., labeled audio training data. Amongst respective time lengths determined for speaking particular words, a maximum time span for speaking a single word is selected. In some embodiments, an additional buffer amount is added to the maximum time span. For example, the time threshold is selected to be 0.5 seconds. Because most words will have already been spoken within that time frame of 0.5 seconds or less, if the time threshold of 0.5 seconds is reached without the acoustic intensity passing below the intensity-level threshold, in response that time threshold is selected for the chunking spot.

In step 210 of the vocal characteristic-based audio data chunking process 200, a determination is made whether the vocal characteristic crosses a threshold value. For example, the program 116 determines whether the acoustic intensity crosses the acoustic intensity threshold value. If the determination of step 210 is affirmative in that the vocal characteristic crosses a threshold value, the vocal characteristic-based audio data chunking process 200 proceeds to step 212. If the determination of step 206 is negative in that the vocal characteristic does not cross the threshold value with the current measurement, the vocal characteristic-based audio data chunking process 200 proceeds back to step 208 for a repeat of step 208. In the example vocal intensity profile graph 402 shown in FIG. 4, a threshold value line 404 (h) is provided at the threshold value for the Y-variable of acoustic intensity. This value at (h) is the threshold value that was received and/or determined in step 202. The provision of the threshold value line 404 (h) on the vocal intensity profile graph 402 illustrates an example of how the program 116 is automatically able to evaluate the acoustic intensity variable line 405. For example, the program 116 recognizes each instance when the acoustic intensity variable line 405 crosses the intensity threshold line 404 (h). FIG. 4 shows a first cross time point 406 at which the acoustic intensity variable line 405 crossed or touched the intensity threshold line 404 (h). Before this first cross time point 406, the acoustic intensity variable line 405 was decreasing in its value until it reached the threshold value line 404 (h) at the first cross time point 406. The first cross time point 406 indicates the X-value of time at which the acoustic intensity threshold line 404 (h) reached, touched, and/or crossed the Y-value of the acoustic intensity threshold value.

Steps 208 and 210 together are a loop which is exited when the determination in one of these steps is affirmative so that the process 200 thereafter proceeds to step 212. For the embodiment shown in FIG. 4 no time threshold is shown but the time threshold is greater than the time of the first cross time point 406. Thus, the process 200 repeated steps 208 and 210 until at one of the iterations of step 210 the acoustic intensity variable line 405 reached the threshold value line 404 (h) at the first cross time point 406. This repeating of the steps 208 and 210 started from the far left of the acoustic intensity variable line 405. An initial upwards crossing of the threshold value line 404 via the acoustic intensity variable line 405 is ignored via the program 116 due to recognition that the audio recording is transitioning from no sound to a voice recording. If neither step 208 nor step 210 is affirmative, the process 200 proceeds back for a repeat of step 208. This loop back proceeds quickly as this repeat iteration of this loop occurs in at least some embodiments multiple times within 0.5 seconds.

In step 212 of the vocal characteristic-based audio data chunking process 200, a chunk of audio data is created based on the time that the threshold was crossed. FIG. 4 shows with the recorded words 408 that the threshold crossings within the recorded audio data (whose acoustic intensity is illustrated in FIG. 4) largely correspond to breaks between words of the recorded spoken phrase. The recorded words 408 in this instance are “fortunately the weather was very good”. As shown in FIG. 4 the first cross time point 406 corresponds to the break between the first word “fortunately” and the second word “the” of these recorded words. At this instance of the process 200, however, the program 116 does not know which words are recorded in the audio test data. Thus, the illustration in FIG. 4 of the recorded words 408 is to help the reader visualize the benefits of the variable-length vocal characteristic-based chunking described herein.

Following the chunk creation of step 212 of the data chunking process 200, multiple audio recording chunks (e.g., first audio chunk 410a, second audio chunk 410b, third audio chunk 410c, fourth audio chunk 410d, fifth audio chunk 410e, sixth audio chunk 410f, etc.) are created and sent separately to the machine learning model for word recognition instead of creating a single longer audio chunk to send to the machine learning model for word recognition. In the first iteration of step 212 for the recorded words 408, the first audio chunk 410a is created. The iteration for additional chunk creation occurs with the process 200 returning after step 218 back to step 206 as will be explained subsequently.

When the microphone of the computer receives the sound an analog recording of the sound is generated via components of the computer 101. Components of the computer 101 perform sampling to produce a digital representation, e.g., binary numbers, that represent the recorded sound and the recorded analog recording. Upon recognition of the threshold crossing in steps 208 or 210, the program 116 ends adding of the digital representation to a single file and makes a copy of the current existing file up to that point. That copy is a chunk that can be used to transmit to the machine learning model. The program 116 then can start a new collection of the digital representation that can be the new chunk at recognition of a subsequent crossing of the threshold.

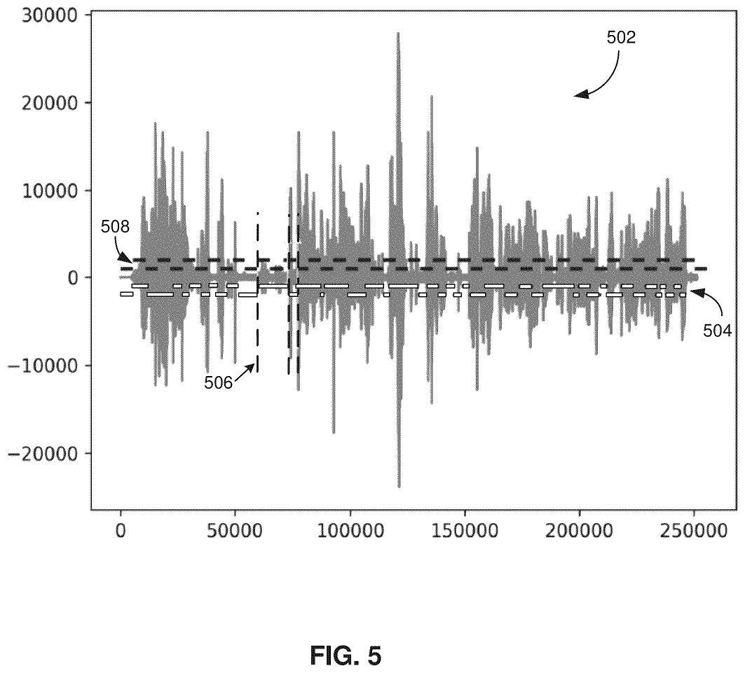

FIG. 5 shows a sound wave recording 502 and illustrates how chunks of sound wave recordings are generated instead of a single large chunk. The sound wave recording 502 includes the intensity of the sound for the Y-variable and the horizontal axis represents time. Upon crossing a threshold, a first end point 506 (with a time equal to the time when the threshold was crossed) of a single digital audio file is used to create a chunk that ends at the first end point 506. A first chunk can extend from the left-most point of the waves shown in the sound wave recording 502 of FIG. 5 to the first end point 506. Vocal characteristic-based variable-length chunks 504 of audio data are illustrated in contrast to standard-length chunks 508 of audio data. The vocal characteristic-based variable-length chunks 504 of audio data facilitate increased accuracy and latency for speech recognition as compared to the results achieved using standard-length chunks 508, because the vocal characteristic-based variable-length chunks 504 of audio data better match breaks in words and are less likely to split up a single word into separate audio files sent to the speech recognition machine learning model.

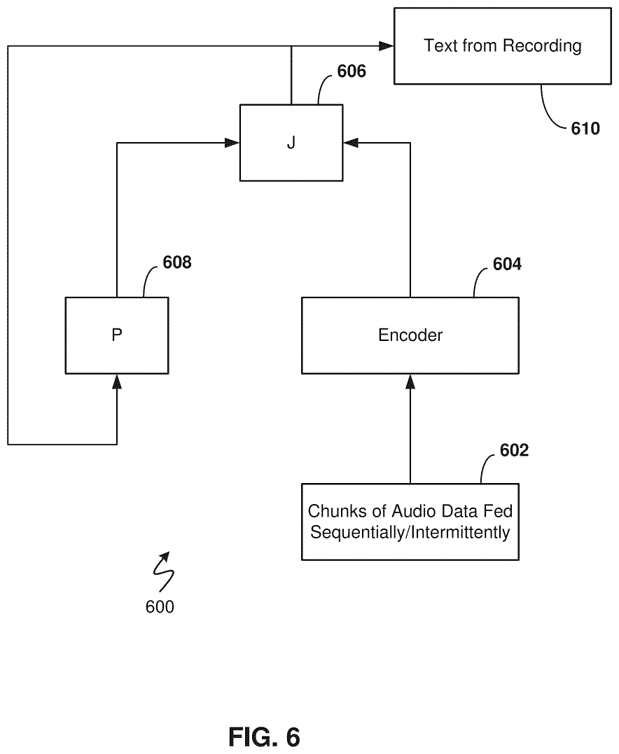

In step 214 of the vocal characteristic-based audio data chunking process 200, the chunk of data is sent to an encoder of an automatic speech recognition model. FIG. 6 illustrates a pipeline 600 for speech-to-text conversion using variable chunk decoding according to at least one embodiment. The pipeline 600 shows in a first step 602 that chunks of audio data are fed sequentially and/or intermittently to an encoder 604 that is part of the machine learning model. In embodiments where the machine learning model is stored and hosted at the same computer, e.g., computer 101, that hosts the program 116, this sending of step 214 is an intra-transmission within the computer, e.g., along a bus of that computer. In embodiments where the machine learning model is stored and hosted at another computer, e.g., remote server 104, that is different and separate from the computer that hosts the program 116, this sending of step 214 includes an inter-transmission step, e.g., via a wide area network 102 as is shown in FIG. 1. By hosting the machine learning model within the same device in which the program 116 is operating, the text recognition and speech-to-text output is produced more quickly.

In step 216 of the vocal characteristic-based audio data chunking process 200, the automatic speech recognition model performs speech recognition with the data chunk. The pipeline 600 shown in FIG. 6 illustrates aspects in some embodiments of how the automatic speech recognition model performs step 216. This pipeline 600 illustrates an example of the machine learning model/automatic speech recognition model being a recurrent neural network transducer. The chunks of audio data (generated as described previously) are fed to an encoder 604 of the machine learning model. The encoder 604 produces a hidden representation of the respective audio data chunk that it receives and sends this hidden representation (vector) to a joiner network 606 of the recurrent neural network transducer. The joiner network 606 combines the vector from the encoder 604 with a vector from a predictor network 608 to produce a softmax over all potential labels of samples (e.g., words) from the audio data. The predictor network 608 also includes an encoder that generates a hidden representation (vector) from its input. The joiner network 606 feeds its output back to the predictor network 608 so that the predictor network 608 is autoregressive and can use previous determinations for predicting a next batch of input data. The joiner network also produces text 610 from the recording so as to achieve speech-to-text transcription. The recurrent neural network transducer can combine multiple texts 610 from various chunks that are input therein in order to produce text for a longer audio sequence. However, using the variable-length vocal characteristic-based data chunking described herein, the recurrent neural network transducer more quickly provides its speech-to-text predictions for captured audio so that a computer can more quickly use and display the text predictions of the captured audio. In at least some embodiments, the produced text 610 is displayed via a display screen of the computer 101 and/or is played audibly via a speaker of the computer 101.

In step 218 of the vocal characteristic-based audio data chunking process 200, a determination is made whether more audio data is present or being received. If the determination of step 218 is affirmative in that more audio data is being received, the vocal characteristic-based audio data chunking process 200 proceeds to step 220 and some steps of the vocal characteristic-based audio data chunking process 200 will be repeated for the additional audio data. If the determination of step 218 is negative in that more audio data is not present or not being received, the vocal characteristic-based audio data chunking process 200 proceeds to an end. In some embodiments, the program 116 performs step 218 by checking a data cache of the computer 101 for storing audio recordings. Finding additional information in the data cache is associated with more audio data being present. Finding no additional information in the data cache is associated with no more audio data being present.

In step 220 of the vocal characteristic-based audio data chunking process 200, the time frame is reset. For the acoustic intensity time graph 402 shown in FIG. 4, for the second iteration the new time frame is set to start at the first time point 406. Thus, the new time frame occurs after, e.g., immediately after, a first time frame in which a first iteration of the steps 206, 208, 212, 214, and 216, and perhaps step 210 was performed.

After step 220 the vocal characteristic-based audio data chunking process 200 proceeds to step 206 for a repeat of steps 206, 208, 212, 214, and 216, and perhaps step 210 in another iteration of the vocal characteristic-based audio data chunking process 200. The repeat iteration produces additional chunks of audio data to send to the speech recognition machine learning model for additional performance of speech-to-text transcription.

It may be appreciated that FIGS. 2-6 provide only illustrations of certain embodiments and do not imply any limitations with regard to how different embodiments may be implemented. Many modifications to the depicted embodiment(s), e.g., to particular steps, elements, and/or order of depicted methods or components of a neural network, may be made based on design and implementation requirements.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The flowchart and block diagrams in the Figures illustrate the architecture, functionality, and operation of possible implementations of systems, methods, and computer program products according to various embodiments. In this regard, each block in the flowchart, pipeline, and/or block diagrams may represent a module, segment, or portion of instructions, which comprises one or more executable instructions for implementing the specified logical function(s).

What is claimed is:

1. A computer-implemented method comprising:
receiving audio data;
examining the audio data by time frame and to obtain a time-dependent vocal characteristic of the audio data;
in response to the time-dependent vocal characteristic crossing a threshold value at a first time point, creating a first chunk of the audio data from the audio data from a beginning time point to the first time point;
sending the first chunk of the audio data to a speech recognition machine learning model; and
iteratively repeating the examining, the creating, and the sending for additional chunks of the audio data.

2. The computer-implemented method of claim 1, further comprising:
in response to a pre-determined time threshold value being exceeded at an additional time point and without creation of another chunk of the audio data since the first chunk was created, creating a second chunk of the audio data from the first time point to the additional time point; and
sending the second chunk of the audio data to the speech recognition machine learning model.

3. The computer-implemented method of claim 1, wherein the first chunk of the audio data is sent to an encoder of the speech recognition machine learning model.

4. The computer-implemented method of claim 1, wherein the speech recognition machine learning model is a recurrent neural network transducer.

5. The computer-implemented method of claim 1, wherein the time-dependent vocal characteristic is selected from a group consisting of intensity, tone, and change in intensity.

6. The computer-implemented method of claim 1, further comprising pre-determining the threshold value based on audio training data.

7. The computer-implemented method of claim 6, wherein the pre-determination of the threshold value comprises identifying one or more local minima of time-dependent vocal characteristic values in the audio training data.

8. The computer-implemented method of claim 7, wherein the identified one or more local minima comprise candidate threshold values and the pre-determination of the threshold value comprises performing statistical analysis on the candidate threshold values.

9. The computer-implemented method of claim 6, wherein the pre-determining comprises:
performing frequency distribution analysis of recorded vocal characteristics from the audio training data and
selecting a bin from the frequency distribution analysis with a lowest number of values as a basis for the threshold value.

10. The computer-implemented method of claim 1, wherein the time-dependent vocal characteristic is intensity and the threshold value is greater than 0 decibels.

11. The computer-implemented method of claim 1, wherein the first time point corresponds to an internal portion of a spoken language cluster whose audio is captured within the first chunk.

12. The computer-implemented method of claim 10, wherein the first time point corresponds to a word boundary of the spoken language cluster.

13. The computer-implemented method of claim 1, further comprising receiving text data from the speech recognition machine learning model in response to sending the first chunk of the audio data to the speech recognition machine learning model, the text data comprising a prediction of the speech recognition machine learning model of a word whose audio is captured within the first chunk.

14. A computer system comprising:
one or more processors, one or more computer-readable memories, and program instructions stored on at least one of the one or more computer-readable memories for execution by at least one of the one or more processors to cause the computer system to:
receive audio data;
examine the audio data by time frame and to obtain a time-dependent vocal characteristic of the audio data;
in response to the time-dependent vocal characteristic crossing a threshold value at a first time point, create a first chunk of the audio data from the audio data from a beginning time point to the first time point;
send the first chunk of the audio data to a speech recognition machine learning model; and
iteratively repeat the examining, the creating, and the sending for additional chunks of the audio data.

15. The computer system of claim 14, wherein the program instructions stored are further for execution by at least one of the one or more processors to cause the computer system to:
in response to a pre-determined time threshold value being exceeded at an additional time point and without creation of another chunk of the audio data since the first chunk was created, create a second chunk of the audio data from the first time point to the additional time point; and
send the second chunk of the audio data to the speech recognition machine learning model.

16. The computer system of claim 14, wherein the first chunk of the audio data is sent to an encoder of the speech recognition machine learning model.

17. The computer system of claim 14, wherein the speech recognition machine learning model is a recurrent neural network transducer.

18. The computer system of claim 14, wherein the time-dependent vocal characteristic is selected from a group consisting of intensity, tone, and change in intensity.

19. A computer program product comprising a computer-readable storage medium having program instructions embodied therewith, the program instructions executable by a computer to cause the computer to:
receive audio data;
examine the audio data by time frame and to obtain a time-dependent vocal characteristic of the audio data;
in response to the time-dependent vocal characteristic crossing a threshold value at a first time point, create a first chunk of the audio data from the audio data from a beginning time point to the first time point;
send the first chunk of the audio data to a speech recognition machine learning model; and
iteratively repeat the examining, the creating, and the sending for additional chunks of the audio data.

20. The computer program product of claim 19, wherein the program instructions stored are further for executable by the computer to cause the computer to:
in response to a pre-determined time threshold value being exceeded at an additional time point and without creation of another chunk of the audio data since the first chunk was created, create a second chunk of the audio data from the first time point to the additional time point; and
send the second chunk of the audio data to the speech recognition machine learning model.
